(19) United States
(12) Patent Application Publication
(10) Pub. No.: US 2012/0166287 A1
(43) Pub. Date: Jun. 28, 2012

(54) WANT ADVERTISEMENT BASED ONLINE MARKETPLACE

(76) Inventors: BRIAN D. DE HAAFF, MENLO PARK, CA (US); CHRISTOPHER J. F. WATERS, LOS ALTOS, CA (US)

(21) Appl. No.: 12/976,863

(22) Filed: Dec. 22, 2010

(51) Int. Cl. G06Q 30/00

(52) U.S. Cl. 705/14.66

(57) ABSTRACT

A computing device to provide want advertisements (want ads) to a plurality of want ad responders in an online marketplace comprising a processor to execute instructions and a memory coupled with the processor. The memory stores instructions cause the processor to generate the online marketplace. The online marketplace includes a want ad responder interaction module, a want ad submitter interaction module, and a want tracker module. The want tracker module is configured to match want trackers with want ads based on details in the want ads and details in the want trackers, and automatically rank the matching want trackers. The want tracker module automatically grants marketplace privileges want ad responders having matching want trackers based, at least, on their respective want trackers' rankings, and charges a fee, that is at most an amount associated with each want tracker, to the want ad responders that were granted marketplace privileges.

### FIELD OF THE INVENTION

Embodiments of the invention relate generally to the field of online marketplaces and more particularly matching want advertisements (want ads) with sellers of goods and services.

### BACKGROUND

Classifieds are a mechanism for sellers to advertise their goods and services and for buyers to find something they wish to buy. Buyers accept the burden of browsing what's available at any given time and contacting sellers to learn more about what they have listed or to consummate a sale. Classified advertising is a form of advertising which is particularly common in newspapers, free ad papers, other periodicals, and increasingly online marketplaces. Classified advertising often differs from standard advertising in that it allows both commercial (i.e., businesses) and non-commercial (i.e., private individuals) sellers to solicit sales for goods and services.

There are many challenges for buyers using classified ads including: the browsing of classified ads is time consuming, the listings of goods and services are limited to only those things sellers chose to post, and the availability of goods and services is often outdated. Auctions also tend to be problematic for buyers because the asymmetry of information benefits the seller. There are many challenges for sellers using classified advertisements including: the time and money required to post classified ads, limited visibility into demand, difficulty in determining if the customer really wants what is being sold, and the time spent waiting for buyers to contact the seller and then responding back to those buyers.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

The invention may best be understood by referring to the following description and accompanying drawings that are used to illustrate embodiments of the invention. In the drawings:

FIG. 1A is a flow diagram illustrating an exemplary method for providing an online marketplace for matching want trackers to want ads according to embodiments of the invention.

FIG. 1B is a flow diagram illustrating an exemplary method for providing an online marketplace for matching want trackers to want ads according to embodiments of the invention.

FIG. 2 is a flow diagram illustrating an exemplary method for posting a want ad according to embodiments of the invention.

FIG. 3 is a flow diagram illustrating an exemplary method for posting a want tracker according to embodiments of the invention.

FIG. 4 is a flow diagram illustrating an exemplary method performed by an online marketplace server for matching want trackers to want ads according to embodiments of the invention.

FIG. 5 is a flow diagram illustrating an exemplary method performed by an online marketplace server for granting privileges to matching want trackers according to embodiments of the invention.

FIG. 6 is a flow diagram illustrating an exemplary method performed by an online marketplace server for granting privileges to matching want trackers according to embodiments of the invention.

FIG. 7 is a flow diagram illustrating an exemplary method performed by an online marketplace server for granting display position based privileges to matching want trackers according to embodiments of the invention.

FIG. 8 is a block diagram illustrating an exemplary online marketplace server coupled to a client computer through a network according to embodiments of the invention.

FIG. 9 illustrates an exemplary mechanism for a buyer to generate a want ad according to embodiments of the invention.

FIG. 10 illustrates an exemplary mechanism for a user to view want ads, responses, and want trackers according to embodiments of the invention.

FIG. 11 illustrates an exemplary mechanism for a seller to generate want trackers according to embodiments of this invention.

FIG. 12 is a block diagram illustrating an exemplary computer system according to embodiments of the invention.

### DETAILED DESCRIPTION

The following description describes methods and apparatus for generating an online marketplace matching want advertisements (want ads) with sellers interested in providing the desired goods or services in the want ads. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

To ease understanding, dashed lines have been used in the figures to signify the optional nature of certain items (e.g., features not supported by a given implementation of the invention; features supported by a given implementation, but used in some situations and not in others).

The techniques shown in the figures can be implemented using code and data stored and executed on one or more electronic devices. Such electronic devices store and communicate (internally and/or with other electronic devices over a network) code and data using non-transitory tangible machine readable medium (e.g., magnetic disks; optical disks; read only memory; flash memory devices; phase-change memory) and transitory machine-readable communication medium (e.g., electrical, optical, acoustical or other forms of propagated signals—such as carrier waves, infrared signals, digital signals, etc.). In addition, such electronic devices typically include a set or one or more processors coupled to one or more other components, such as a storage device, one or more input/output devices (e.g., keyboard, a touchscreen, and/or a display), and a network connection. The coupling of the set of processors and other components is typically through one or more busses or bridges (also termed bus controllers). The storage device and signals carrying the network traffic respectively represent one or more non-transitory tangible machine readable medium and transitory machine-readable communication medium. Thus, the storage device of a given electronic device typically stores code and/or data for execution on the set of one or more processors of that electronic device. Of course, one or more parts of an embodiment of the invention may be implemented using different combination of software, firmware, and/or hardware.

In embodiments of this invention, the traditional classified online marketplace is turned on its head. Instead of sellers posting goods and services, buyers post advertisements for what they want, want ads, and sellers access those of the want ads that appeal to them. This creates a place and a system to match buyers with potentials sellers where want ads can be listed and sellers are motivated to find and negotiate with buyers who want what the seller is looking to provide. While many want ads are for material goods, want ads can also be for services, relationships, advice, information, etc. Further, some wants ads might be satisfied with the transfer or money for a good or service while other transactions may have no associated cash value.

A want ad is an advertisement for something that a user (also referred to as a buyer because of the traditional buyer-seller transaction) needs or desires this is accessible by a group of potential want ad responders. The buyer then posts a request for that thing online in a marketplace provided by embodiments of the invention. In one embodiment, the group of potential want ad responders comprises all members of the online marketplace. In another embodiment, the buyer can select one or more other members of the online marketplace as a group and can designate for only members in that group to access the want ad. Still other embodiments allow the buyer to restrict access to the want ad based on other members' attributes (e.g., commercial or non-commercial status, geographic location, age, gender). Want ads can advertise a desired product (either new or used), a desired service, a desired relationship, a desire to receive a recommendation, or a desire to receive general comments on a topic. The desired subject of the want ad is referred to as the want. In the want-based service of embodiments of this invention, a person can post what he wants in an online marketplace and have others (e.g. sellers such as businesses and individuals) respond with offers to provide what is listed in the want ad. In this way, the burden of shopping is shifted from the buyer searching through a list of seller's advertisements to sellers sifting through a list of buyer's want ads. Further, sellers are motivated to monitor want ads and match what they have to offer with buyers' desires. Businesses have more exposure into what a potential buyer wants and buyers benefit from sellers approaching them. Through a response system, at least some of the sellers will have to compete through bids for different communication privileges regarding the want ads and, thus, the opportunity to satisfy the needs listed in the buyers' want ads.

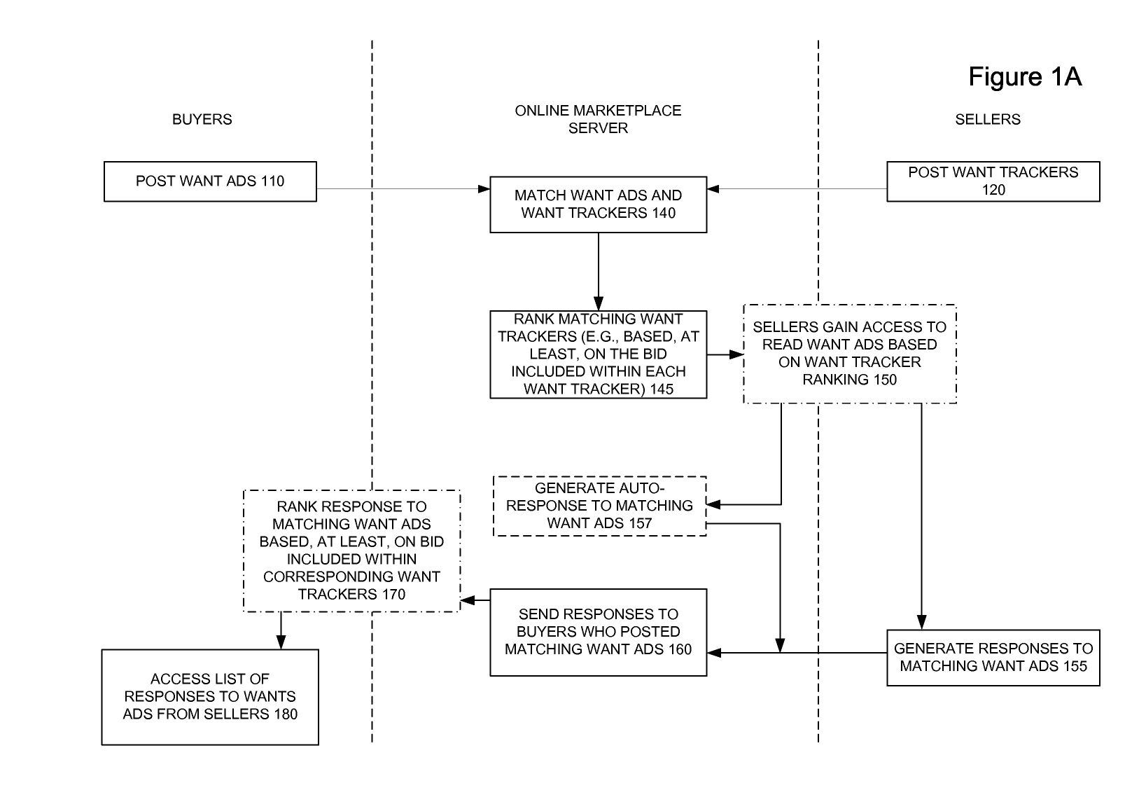

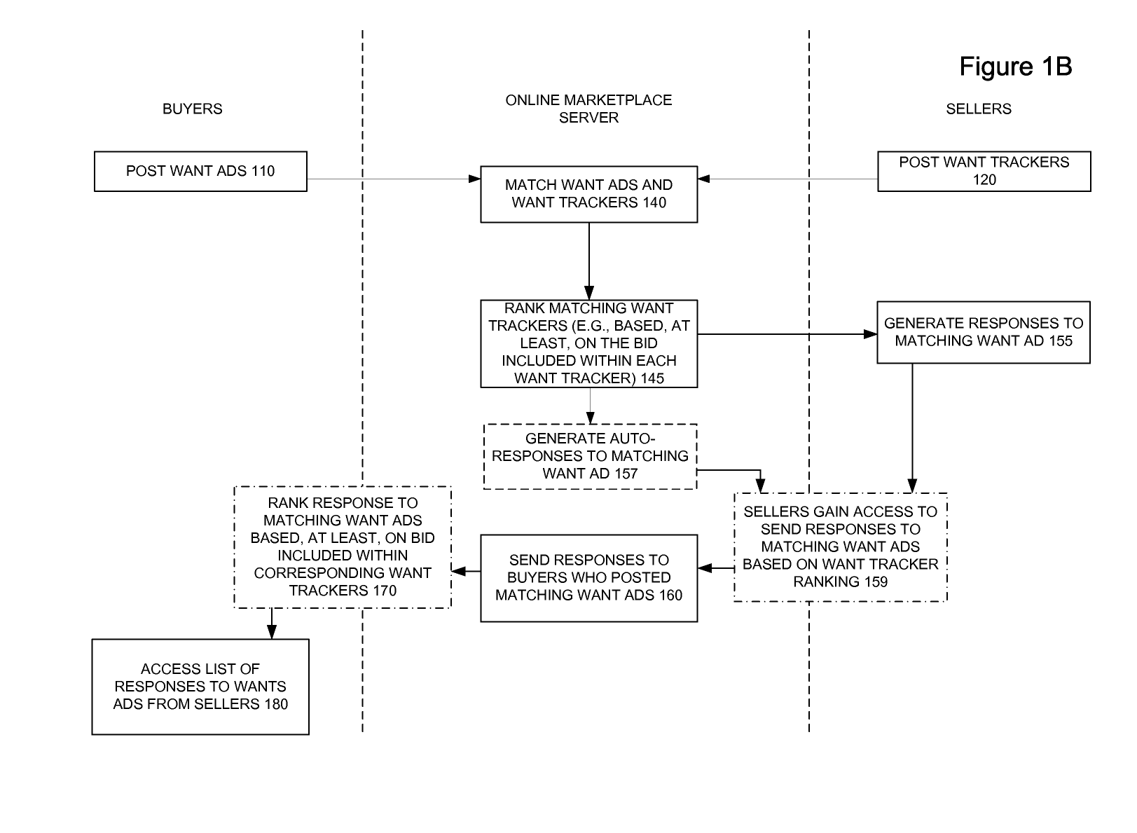

FIG. 1A is a flow diagram illustrating an exemplary method for providing an online marketplace for matching want trackers to want ads according to embodiments of the invention. In FIG. 1A, steps are shown as occurring from actions taken by the buyers (in the far left column), the system (in the middle column) and the seller (in the far right column); each actor is separate by a dashed line.

The buyer column begins at block 110 with the buyer posting information to an online marketplace server that is used to generate one or more want ads. As previously described, the term want ad identifies a desire for something posted by an entity that may or may not be willing to compensate in some fashion the entities that respond.

For a given want ad, one entity acts as the want ad submitter and a set of zero or more entities act as matching want ad responders; it should be noted that a given entity may act as both a want ad submitter with regard to one want ad and a want ad responder with regard to another. Within the online marketplace, the potential want ad responders submit want trackers, which each include a description of something and a bid amount for marketplace privileges. At some later time, a want including a description of something is submitted by a want ad submitter. In response, the online market place determines which of the want trackers describe the same something as the want ad (and thus, determines a set of zero or more matching want ad responders), and uses the corresponding bid amounts for marketplace privileges to determine which of the matching want ad responders get to respond to the want ad, when each of the matching want ad responders gets to respond to the want ad, and/or the manner of display of responses from the matching want ad responders to the want ad.

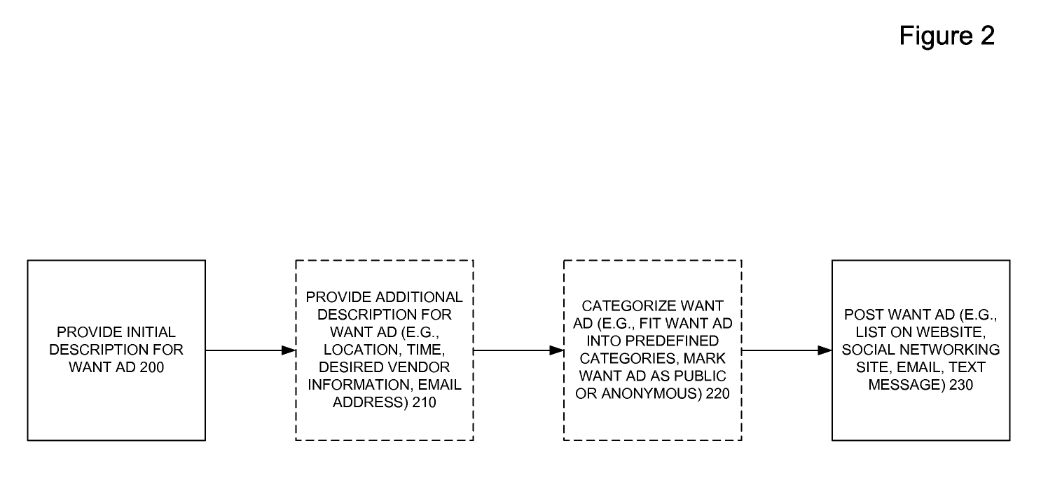

Thus, the terms buyer and seller are respectively used herein to refer to the roles, want ad submitter and want ad responder respectively, played by the entities that submit the want ad and respond, even though there may be no commercial transaction. The “something” wanted can be good(s), service(s), relationship(s), advice, information, recommendation(s), etc. However, for ease of understanding, many of the examples used herein involve an exchange of goods/services for monetary compensation. The information posted in 110 will describe the corresponding want and include additional details the online marketplace uses to generate the want ad as described with reference to FIG. 2.

The posting of a want ad as shown in 110 can be further described with reference to FIG. 2. FIG. 2 is a flow diagram illustrating an exemplary method for posting a want ad according to embodiments of the invention. The figure begins in block 200 with the buyer providing an initial description of the want. In one embodiment, the initial description of the want is a brief textual description to succinctly describe the want (e.g., 1-2 sentences, less than 140 characters). In one embodiment, the initial description of the want is used as the title for the corresponding want ad, while in another embodiment, the initial description is thorough description of the want as entered by the buyer (e.g., a paragraph) and a shortened version of the initial description is used as the title for the want ad. Optionally, the method continues at block 210 with the buyer providing additional description for the want ad. For example, the buyer can enter information indicating a desired location at which the buyer would like the want fulfilled (e.g., within a city, a certain distance from a city, a zip code, a state, etc.), a desired time for fulfillment, information identifying a desired vendor, or a contact email address at which to contact the buyer. The method, optionally, continues at 220 with the buyer categorizing the want ad. In one embodiment, the buyer selects one or more predefined categories to fit the want ad within a classification system while in other embodiments the buyer includes keywords to classify the want ad. In another embodiment, the buyer classifies the want ad as either public or anonymous. A public want will be listed with information so that the seller can identify the buyer as associated with the want ad, while an anonymous want ad will be listed in a way the seller cannot, at least initially, associate the want ad with the buyer. The method continues at block 230 with the buyer posting the want ad. In one embodiment of the invention, the want ad is shared (i.e., transmitted) on a website dedicated to the online marketplace in response to the buyer posting the want ad in block 230 and later displayed to other visitors on the website. In another embodiment of the invention, the want ad is shared through a social networking site, email, or text messaging. In yet other embodiments of the invention, want ad is shared in all of the ways listed or in some combination of the ways listed.

Referring back to FIG. 1A, the far-right seller column begins at block 120 with the seller posting information to the online marketplace server that is used to generate one or more want trackers. A want tracker is a collection of settings that is used by the online marketplace server to match with existing want ads and newly created want ads as buyers generate them. The online marketplace server notifies sellers that one or more buyers have posted want ads to which the seller might want to respond based on the matches between want ads and want trackers. Thus, the information posted by the seller in 120 corresponds with goods, services, relationships, advice, information, or recommendations that the seller would like the opportunity to provide to buyers.

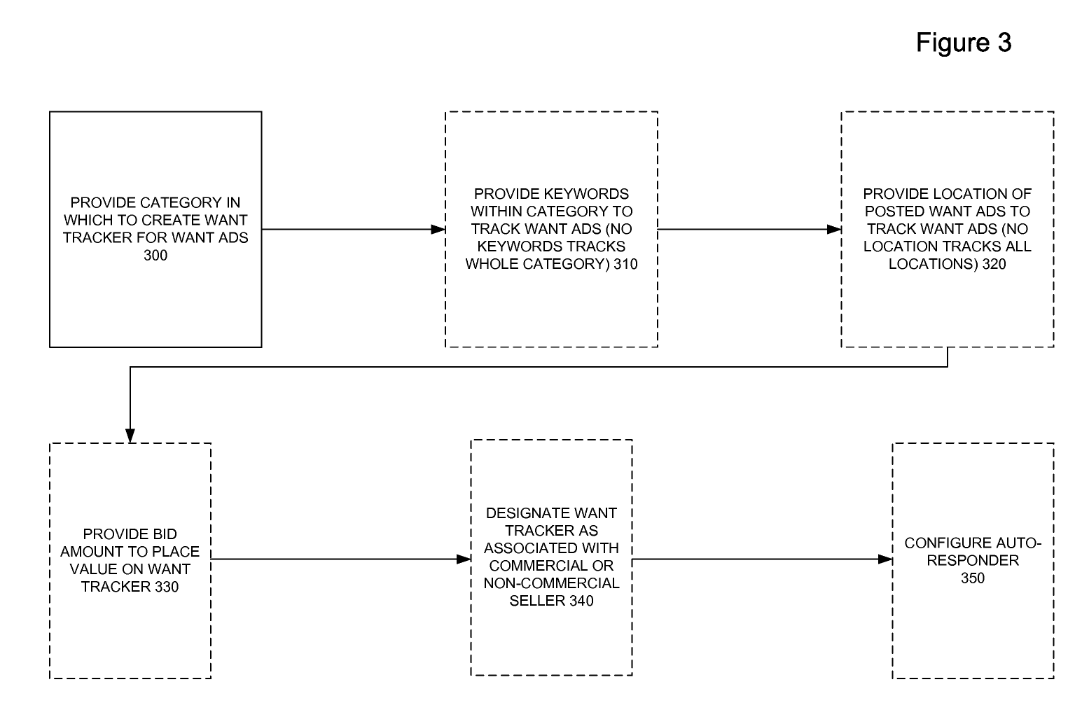

The posting of a want tracker as shown in 120 can be further described with reference to FIG. 3. FIG. 3 is a flow diagram illustrating an exemplary method for posting a want tracker according to embodiments of the invention. The figure beings in block 300 with the seller providing a category in which to create a want tracker. In one embodiment, the seller provides key words used by the online marketplace to determine which categories will be used for that want tracker. In another embodiment, the seller selects amongst predefined categories to determine which category, or categories, will be used for that want tracker. The method continues, optionally, in block 310 with the seller providing keywords to use within the category to track particular subject matter of the want ads. In embodiments utilizing keywords, the seller may chose not to enter keywords in order to track all want ads categorized in the categories provided in block 300. The method continues, optionally, in block 320 with the seller providing a desired location at which the seller would like to fulfill want ads. In embodiments utilizing the location, the seller may chose to not enter a location in order to track want ads in all locations. The method optionally continues at block 330 with the seller providing an amount to place a value on the want tracker. While in other embodiments, the seller receives limited information on want ads that are matched to the seller's want trackers, and the seller then decides to whether to bid on receiving privileges with regard to each of the matching want ads. For example, the seller could receive the want ad, but not information on who the buyer is or how to contact them.

The amount is used by the seller to indicate the worth the seller places on receiving want ads that match that particular want tracker. For example, a generalized tracker may not be worth as much to the seller as a particularized tracker. If the seller has a European used car dealership in Redwood City, Calif., then a want tracker for all used cars within Northern California may be of little value to the seller because of the number of matching want ads that the seller may not want to respond to. At the same time, the seller may place a high value on a want tracker with keywords of “European used cars” and a location of “within 50 miles of Redwood City,” as want ads that meet this criteria have a higher potential to lead to a sale when the seller responds. In one embodiment, the seller is charged for receiving privileges for each want ad that is matched to that seller's want trackers based upon a bid amount the seller places on the matched want trackers. For example, the seller may choose to bid ten cents per matching want ad for a particular want tracker and each want ad that is matched by that tracker would cost the seller ten cents. In another embodiment, the system charges the seller at maximum, the amount the seller bid when granting the seller privileges but may, depending on the particular circumstances of matching the want ad with the want tracker, charge the seller less than the bid amount (e.g., when there is a lot of competition between sellers and a want ad the charge would be higher than when there is little competition). In another embodiment, the seller purchases a preset amount of bids and an amount of bids are debited for each matching want ad based primarily on the bid amount. For example, ten bids may cost the seller one dollar and the seller may choose to place two bids on a want tracker such that the online marketplace sever debits two bids for each matching want ad. In yet another embodiment, the seller is charged a flat fee amount associated with the want tracker for receiving privileges for each want ad that is matched to that seller's want trackers based upon the bid the seller places on the matched want trackers.

The method of FIG. 3 continues, optionally, with the designation of the want tracker as being a commercial or non-commercial want tracker at block 340. In one embodiment, the seller makes the designation for each want tracker that the seller generates. In other embodiments, the seller is known to the online marketplace server as a commercial or non-commercial entity and marks that seller's want trackers accordingly. In one embodiment, the online marketplace server knows the seller is a commercial or non-commercial entity because the seller indicated a status when the seller generated an account in the online marketplace. In another embodiment, the online marketplace server analyzes the seller's activity within the online marketplace and makes a determination that the seller is a commercial entity. In yet another embodiment, the online marketplace server relies upon feedback from buyers as the buyers have interactions with the sellers to designate a seller as a commercial or non-commercial entity. In other embodiments, the seller is allowed to configure each want tracker as commercial or non-commercial as the seller may act in a commercial capacity for some transactions and act in a non-commercial capacity for other transactions.

The method of FIG. 3 continues, optionally, with the seller configuring an auto-responder associated with this want tracker at block 350. An auto-responder is configured with a customizable, seller defined message that will be used by the online marketplace server to automatically generate a response from the seller to the buyer for want ads that match that want tracker. In one embodiment, the seller is only allowed to configure an auto-responder when generating a want tracker for which the seller has entered a bid value greater than zero. In other embodiments, the seller is allowed to configure an auto-responder for each want tracker regardless the bid value the seller placed on the want tracker.

Referring back to FIG. 1A, the online marketplace server matches the want trackers posted by sellers with the want ads posted by buyers at block 140 in the center column. The online marketplace server creates a match between the want ads and the want trackers and assigns a match score to the match corresponding to the quality of the match. In this way, higher quality matches receive higher scores than lower quality matches. Using the initial description, additional description, categorization, requested vendor, etc. from each want ad, the online marketplace server scores the match to each want tracker based on those want trackers' categories, keywords, location, commercial/non-commercial status, etc. to generate a match score for each match. Many want trackers will not match with many want ads because the details in the want ads do not correspond with the details in want trackers. In one embodiment, a want ad with a categorization that is different from a want tracker receives a low match score while in another embodiment the online marketplace server considers these two as having no match. For example, a want ad that is categorized as a want for a good would have a low match score with a want tracker for providing a service, or a want ad listed for non-commercial vendors would generate low match scores with want trackers from commercial sellers; depending on the implementation these same scenarios would be considered no match between the want ad and want tracker. In other embodiments, the match score further takes into account a bid value that the seller placed on the want tracker.

The seller receives notification of want ads that match the want tracker. In one embodiment of the invention, the matching want ads are listed to the seller on a website dedicated to the online marketplace and the seller is notified of the matching want ads when accessing the website. In another embodiment of the invention, the seller receives notification of matching want ads via email, text messaging, phone call, or through a message on a social networking site. Still further embodiments of the invention allow the online marketplace server to send a description of one or more of the matching want ads along with the notification of the match. In yet other embodiments of the invention, the seller is notified of the one or more matching want ads in all of the ways listed or in some combination of the ways listed.

As want ads are matched with want trackers, the online marketplace server continues at block 145 by ranking the matching want trackers according to a number of criteria. The ranking of the matching want trackers allows for the online marketplace server to grant privileges to the sellers of the corresponding want trackers depending upon the rank of each seller's want tracker. In one embodiment, the ranking of the matching want trackers is based upon the bid value each seller assigned to each want tracker. The sellers that placed higher values on the matching want trackers receive a higher ranking and are given priority with respect to the privileges assigned to the sellers with matching want trackers. In one embodiment, different or additional factors are used to rank the want trackers such as each seller's reputation and/or the match score. With respect to the seller's reputation, buyers are given an opportunity to assess sellers with whom the buyer has interacted (e.g., a numerical score, a star based score, a thumbs-up or thumbs-down, etc.) and the assessment is combined with other buyers' assessments to generate the seller's reputation. Buyers can also add comments about a seller and those comments are made available on the seller's profile page. Thus, the online marketplace allows users of the marketplace to self-regulate activity based upon sellers' reputations.

In FIG. 1A, the online marketplace server determines whether to grant each of the seller's with matching want trackers access to read the want ads that match the want trackers, block 150. The access to read privilege is shown between the online marketplace server column and the sellers column after the ranking of the want trackers in block 145 and before sellers generate responses to matching want ads, block 155, and before an optional auto-response is generated by the online marketplace server, block 157. In FIG. 1A and FIG. 1B, privileges are illustrated in dashed-dotted boxes as privileges are optional in embodiments of the invention and may be combined in embodiments of the invention.

In one embodiment, the access to read privilege is granted at a specified time based upon each want trackers' ranking. The want tracker with the highest ranking (ranked first) would be given the first available time slot to read the want ad, the second ranked want tracker would be given the second available time slot to read the want ad, and so on until the lowest ranked want tracker would be given the last available time slot to read the want ad. As soon as the designated time slot for a matching want tracker is reached, the corresponding seller would be given access to read the corresponding want ad. Thus, the seller with the highest ranked want tracker would have the time based advantage of earlier access to read the want ad.

In another embodiment, the access to read a matching want ad is not time based but instead is based on access or no access to read the matching want ads. Thus, seller's whom are granted access will be able to read and, subsequently, respond to the matching want ads but seller's without access will be prevented from reading and, subsequently, responding to the matching want ads.

In one embodiment, sellers are able to generate responses to the buyer with the matching want ads 155, or optionally an auto-response to the buyer is generated by the online market place server 157, as soon as the seller is able to read the want ad. In another embodiment, the ability to send a response to the buyer with the matching want ad is a privilege based upon each want trackers' ranking as described with respect to FIG. 1B.

At the bottom of the online marketplace server column, the online marketplace server sends responses to the corresponding buyers. In one embodiment, this is displayed as a listing of responses on the online marketplace's website while in other embodiments the responses to the want ads are sent via email, text messaging, phone call, or through a message on a social networking site. With respect to embodiments utilizing a listing of responses on the online marketplace's website, another possible privilege is a priority position in the ordering of the list of responses from sellers. Shown between the online marketplace server column and the buyers column in block 170, this privilege is that each response from a seller to the matching want ad is ordered based on the ranking given to that seller's want tracker in block 145. The list of responses is shown such that responses from the seller with the highest ranked want tracker will be displayed with priority as the buyer accesses a list of responses to that buyer's want ad in block 180. In one embodiment, the order of the responses is set by the ranking of the corresponding matching want trackers while in another embodiment, the responses are presented to the buyer one at a time in the order based upon the rankings of the want trackers.

FIG. 1B is a flow diagram illustrating an exemplary method for providing an online marketplace for matching want trackers to want ads according to embodiments of the invention. FIG. 1B is identical to FIG. 1A, except rather than granting an access to read privilege, the online market place server grants seller's an access to send responses to want ads privilege.

The privilege of gaining access to send responses to the buyers with matching want ads is shown in block 159. In one embodiment, the access is granted at a specified time based upon each of the matching want trackers' ranking. In another embodiment, the access to send responses to the buyers with matching want ads is not time based but instead is based on access or no access to send responses to the matching want ads. This privilege is shown between the online marketplace server column and the sellers column after the sellers are able to generate responses to the buyer with the matching want ads 155, or the optionally generated auto-response to the buyer 157, and before the online marketplace server sends the responses to the buyers. In one embodiment, a seller is able to generate a response 155, or an auto-response is generated based on that want tracker's auto-responder 157, to the want ad as soon as that seller is able to read the want ad, but the online marketplace server prevents the transmission of the response to the buyer until it reaches the time slot corresponding to that seller's time slot, which is assigned based upon the ranking of all the matching want trackers as described above. In another embodiment, the seller is not able to generate a response on the online marketplace server before the online marketplace server reaches the timeslot assigned to that seller's want tracker.

While the privileges in FIG. 1A and FIG. 1B have been described individually, one skilled in the art would recognize that the privileges described above may be used in conjunction with one another or individually from one another. Furthermore, the online marketplace server may use one set of privileges for one set of want trackers or want ads and another set of privileges for another set of want trackers or want ads or some combination thereof.

With respect to reading want ads at a specific time and sending responses at a specific time slot, the time slots may be specific times (e.g., 3:35 PM for rank 1, 3:40 PM for rank 2, . . . , 6:00 PM for the lowest rank) or may be a specified delay period from the posting of the want ad (e.g., 0 minutes for rank 1, 2 minutes for rank 2, . . . , 48 minutes for the lowest rank). In one embodiment, the times slots used by the online marketplace server depend upon the number of matching want trackers for a particular want ad (e.g., if there are 10 matching want trackers than there are 10 time slots). In another embodiment, the time slots used by the online marketplace server are tiered such that a first set of the highest ranking want trackers are assigned to the first time slot, the next set of want trackers are assigned to the second time slot, and so on until all of the want trackers are assigned to a time slot. In one embodiment of the invention, once a privilege is granted the seller retains that privilege even after the next time slot begins. In another embodiment of the invention, the online marketplace server rescinds previously granted privileges some period of time after those privileges were granted (e.g., once the next time slot begins).

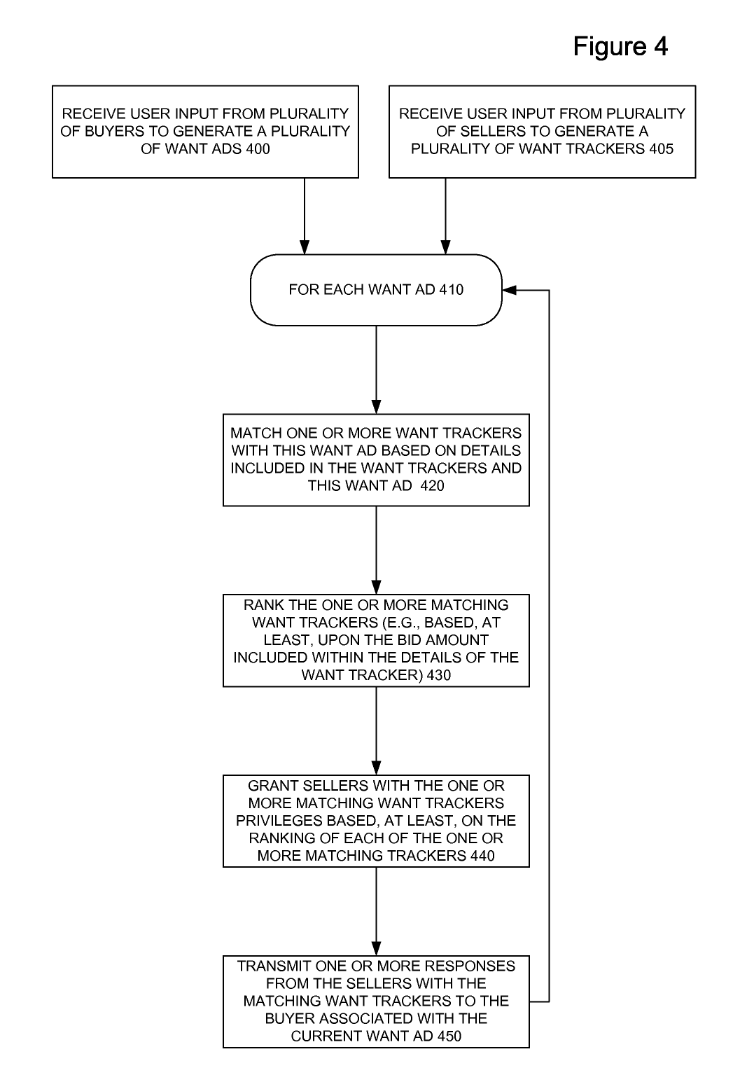

FIG. 4 is a flow diagram illustrating an exemplary method performed by an online marketplace server for matching want trackers to want ads according to embodiments of the invention. The method begins at the top with blocks 400 and 405. In block 400, the online marketplace server interacts with a plurality of buyers to receive user input from those buyers to generate a plurality of want ads. In block 405, the online marketplace server interacts with a plurality of sellers to receive user input from those sellers to generate a plurality of want trackers. For each of the plurality of want ads generated in block 400, the online marketplace server performs the following steps, block 410. In block 420, the online marketplace server matches one or more of the plurality of want trackers with the current want ad based on details included in the want trackers and the want ad. The online marketplace server ranks the one or more matching want trackers (e.g., based, at least, upon bid amounts included within the details of the matching want trackers) in block 430. The online marketplace server grants the sellers with the matching want trackers privileges associated to the current want ad in block 440 based at least on the ranking of each of the one or more matching want trackers. The online marketplace server then transmits one or more response from the sellers with the matching want trackers to the buyer associated with the current want ad in block 450. For example, the online marketplace server can display the responses on a website, send the responses to a mobile device, send the responses to an email address, post the responses on a social networking site, or post the responses to another third party system.

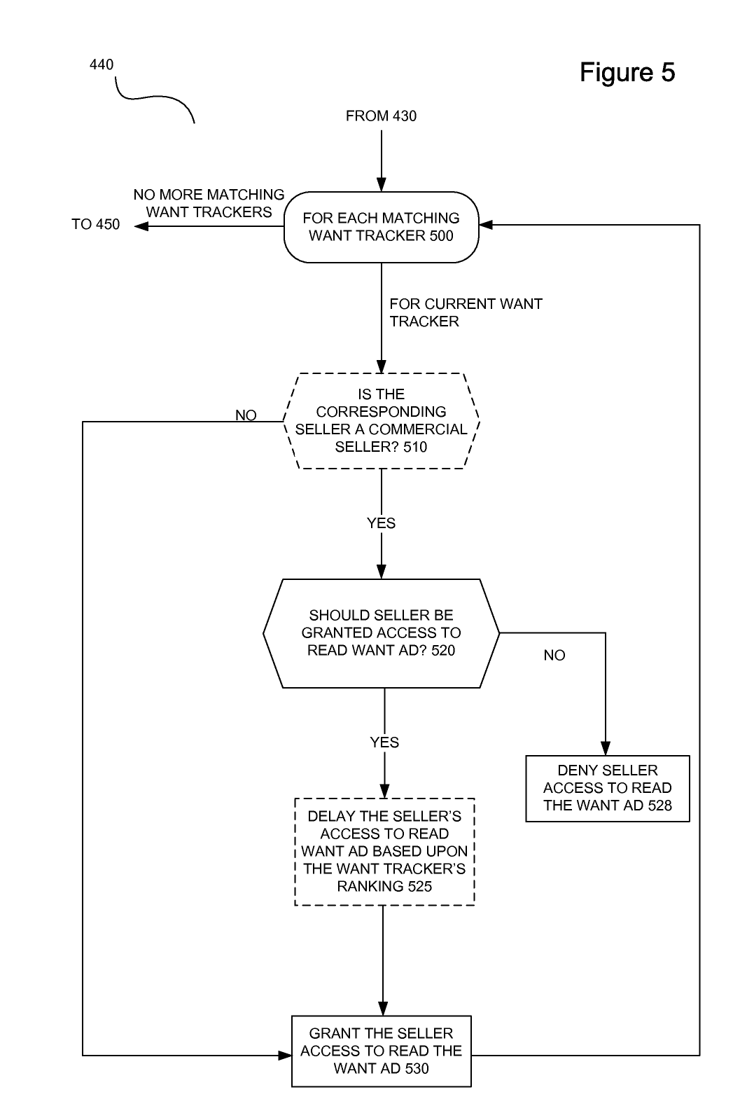

FIG. 5 is a flow diagram illustrating an exemplary method performed by an online marketplace server for granting privileges to matching want trackers according to embodiments of the invention. Specifically, FIG. 5 shows one method for implementing block 440 from FIG. 4. The online marketplace server loops through each of the ranked matching want trackers from 430 beginning in block 500. Once, the online marketplace server has no more matching want trackers to process, it continues on to block 450. For each of the matching want trackers, the online marketplace server performs the following steps. In one embodiment, the online marketplace server checks if the current want tracker is associated with a commercial or non-commercial seller in block 510. If the seller is a non-commercial seller, the online marketplace server grants the seller access to read the want ad in block 530. In embodiments in which no commercial seller versus non-commercial seller check is performed, or when the seller is a commercial seller, the online marketplace server continues at block 520 with determining if the seller should be granted access to read the want ad based on the want tracker's ranking. In one embodiment, the determination of whether to grant access to the seller is based on that seller's want tracker ranking such that sellers with a higher ranking have a higher chance of being granted access. In another embodiment, all sellers will be granted access to read the want tracker but some seller's may experience a delay before access is granted. If it is determined that a seller should not be granted access, the method continues with denying the seller access to read the want ad at block 528. If it is determined the seller should be granted access to read the want ad then the method continues with, optionally, delaying the seller's access to read the want ad at block 525. The length of time delay is based upon that want tracker's ranking from block 430. The method continues with the online marketplace server granting the seller access to read the want ad in block 530; in embodiments with a time delay from block 525 the granting of access occurs after the time delay expires. In one embodiment, the online marketplace processes each want tracker one at a time in a serial fashion. In another embodiment, the online marketplace processes each want tracker in parallel and sets the time delay based upon that want tracker's ranking without waiting for the time delay of each of the higher ranking want trackers to expire.

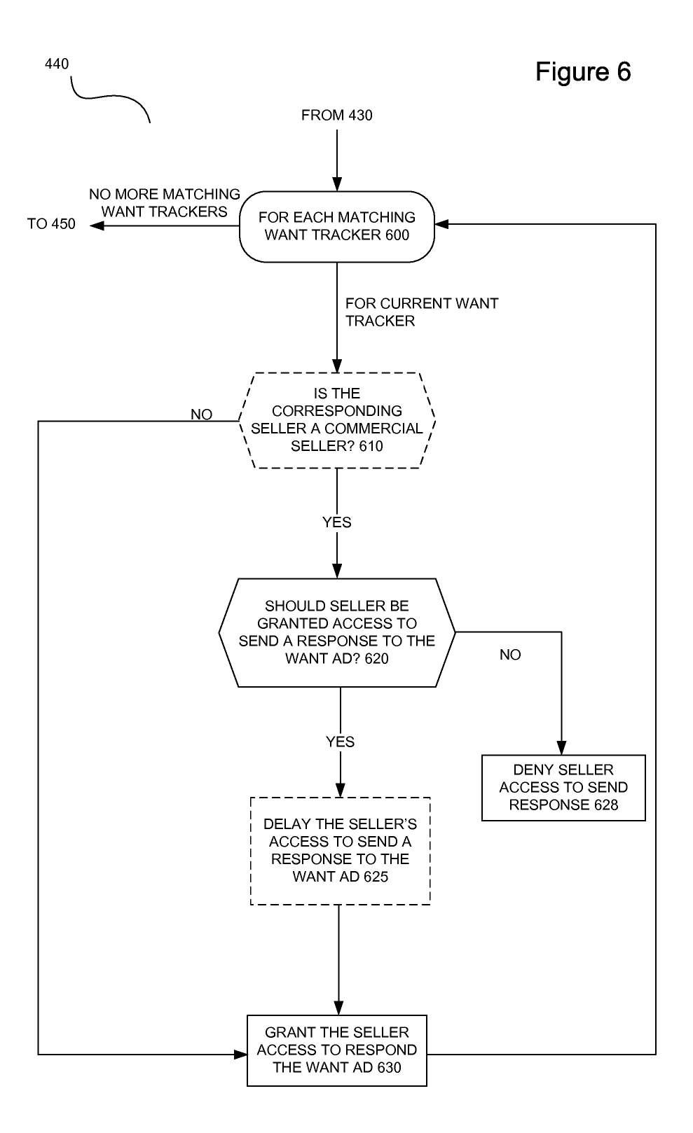

FIG. 6 is a flow diagram illustrating an exemplary method performed by an online marketplace server for granting time delay based privileges to matching want trackers according to embodiments of the invention. FIG. 6 is identical to FIG. 5 except that the online marketplace server is determining whether to grant the seller's access to send a response to the want ad in block 620, delaying the seller's access to send a response to the want ad in block 625, denying the seller access to send a response in 628, and granting the seller access to send a response to the want ad in block 630.

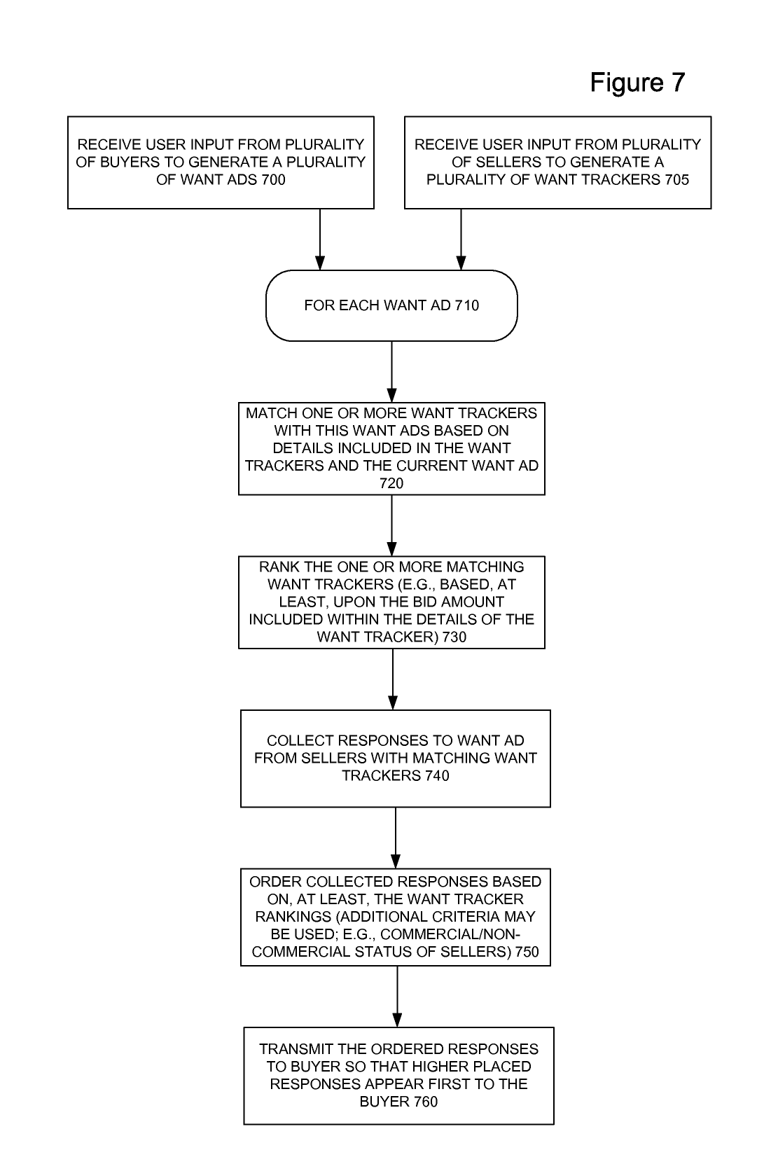

FIG. 7 is a flow diagram illustrating an exemplary method performed by an online marketplace server for granting display position based privileges to matching want trackers according to embodiments of the invention. The method begins at the top with blocks 700 and 705. In block 700, the online marketplace server interacts with a plurality of buyers to receive user input from those buyers to generate a plurality of want ads. In block 705, the online marketplace server interacts with a plurality of sellers to receive user input from those sellers to generate a plurality of want trackers. For each of the plurality of want ads generated in block 700, the online marketplace server performs the following steps, block 710. In block 720, the online marketplace server matches one or more of the plurality of want trackers with the current want based on details included in the want trackers and the want ad. The online marketplace server ranks the one or more matching want trackers (e.g., based, at least, upon bid amounts included within the details of the matching want trackers in block 730). The online marketplace server collects responses to the want ad from sellers with matching want trackers in block 740. In block 750, the online marketplace server orders the collected responses based on at least each seller's want tracker's ranking. Additional criteria may be used to order the collected responses. For example, the commercial or non-commercial status of each seller may affect the ordering such that buyers with a preference for commercial sellers see responses from commercial sellers first and buyers with a preference for non-commercial sellers see responses from non-commercial sellers first. In block 760, the online marketplace server continues by transmitting the ordered responses to the buyer so that higher placed responses appear to the buyer before lower placed responses. In one embodiment, only a certain number of the highest placed responses are transmitted to the buyer (e.g., the top ten responses are transmitted to the buyer and the rest of the responses are discarded by the online marketplace server).

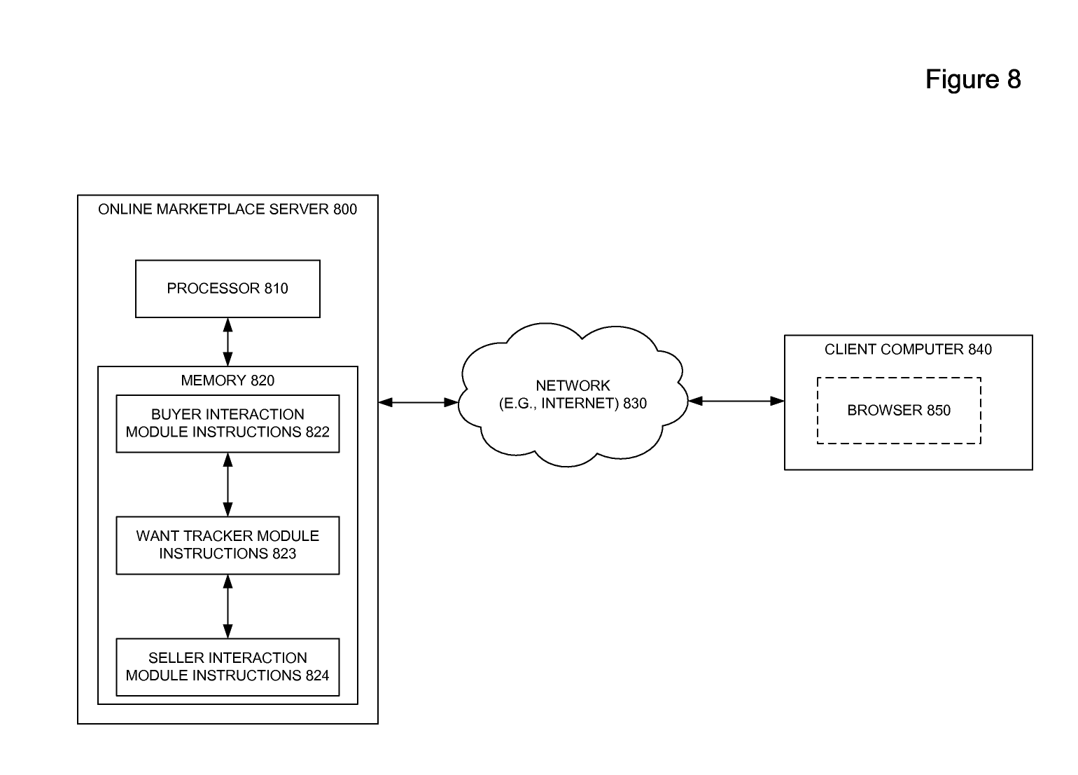

FIG. 8 is a block diagram illustrating an exemplary online marketplace server coupled to a client computer through a network according to embodiments of the invention. The online marketplace server 800 comprises a processor 810 which is coupled to a memory 820. The memory 820 comprises buyer interaction module instructions 822, want tracker module instructions 823, and seller interaction module instructions 824. The want tracker module instructions 823 are coupled to the buyer interaction module instructions 822 and the seller interaction module instructions 824. The processor 810 is configured to retrieve the instructions from the memory 820 and execute the instructions to perform the operations described herein.

The client computer 840, may be in one instance operated by a buyer in communication with the online marketplace server 800 through a network 830 (e.g., the Internet). In another instance, the client computer 840 is operated by a seller in communication the online marketplace server 800. In another embodiment, the client computer 840 is operated by a user acting as both a buyer and a seller. The client computer 840 is adapted to run the necessary protocols and software to communicate with the online marketplace server 800. For example, the client computer 840 executes a web browser 850 in embodiments of the invention in which the online marketplace server 800 provides the online marketplace through a web site interface.

Anyone can use the online marketplace website assuming they abide by the terms of service. All users will be able to search for want ads and users may optionally register to post or respond to want ads. Further, users may have multiple accounts if they so desire and each account may have a different user profile (e.g., a buyer as one account and a seller as another account). Users may also use one account for both acting as a buyer on one occasion and a seller on another occasion. Upon registration, users will be able to select an identifier or username for that account that will be displayed as associated with various want ads and responses to want ads that originate from that user account. In embodiments allowing for anonymous want ads, the user may choose to mark a want ad as anonymous in which case the want ad will be displayed without a username displayed to viewers. When sellers respond to an anonymous want ad, the response is transmitted to the buyer in the same manner as public want ads. Another function of the online marketplace website is the ability for users to forward want ads along to other individuals, both users of the website and non-users of the website.

When a buyer generates a want ad, the want ad can be for anything that users wish to communicate and some want ads may not be need, or perceived need, based. Another consideration of wants ads is that during the posting process the user may elect to have the want ad posted to other forums or social media sites. Posting of the want ad to other forums or social media sites can happen automatically if the user provides the online marketplace with authorization to do such a posting. Alternatively, system will automatically generate the corresponding hypertext markup language (HTML) code corresponding to a want ad, or a number of the user's want ads, that can be copied and pasted into other sites by the user. The HTML code will generate links back to the want ad on the online marketplace website and may also contain the title and/or images corresponding with the want ad.

Users, both buyers and sellers can create lists of want ads they are following, as opposed from using a want tracker. For example, a user may want to track all the want ads generated by that user's acquaintances during the holiday season. Further, the user may share those lists with other users, mark a list public to make the lists available to other users, or mark the list private so that only individuals with access to that user account can see the list. Since lists are manually generated by users, the list allow for the aggregation of want ads based on criteria and filters that are not part of the online marketplace server as a user aggregates the want ads based on their own criteria. Further, a first user tracking another user's want ads may see something he would like as well. When looking at another user's want ads, the first user is presented a “I want it too” link that would generate a want ad for the first user with the details from the want ad being viewed. The first user may wish to edit the specific details of the new want ad to precisely fit his needs.

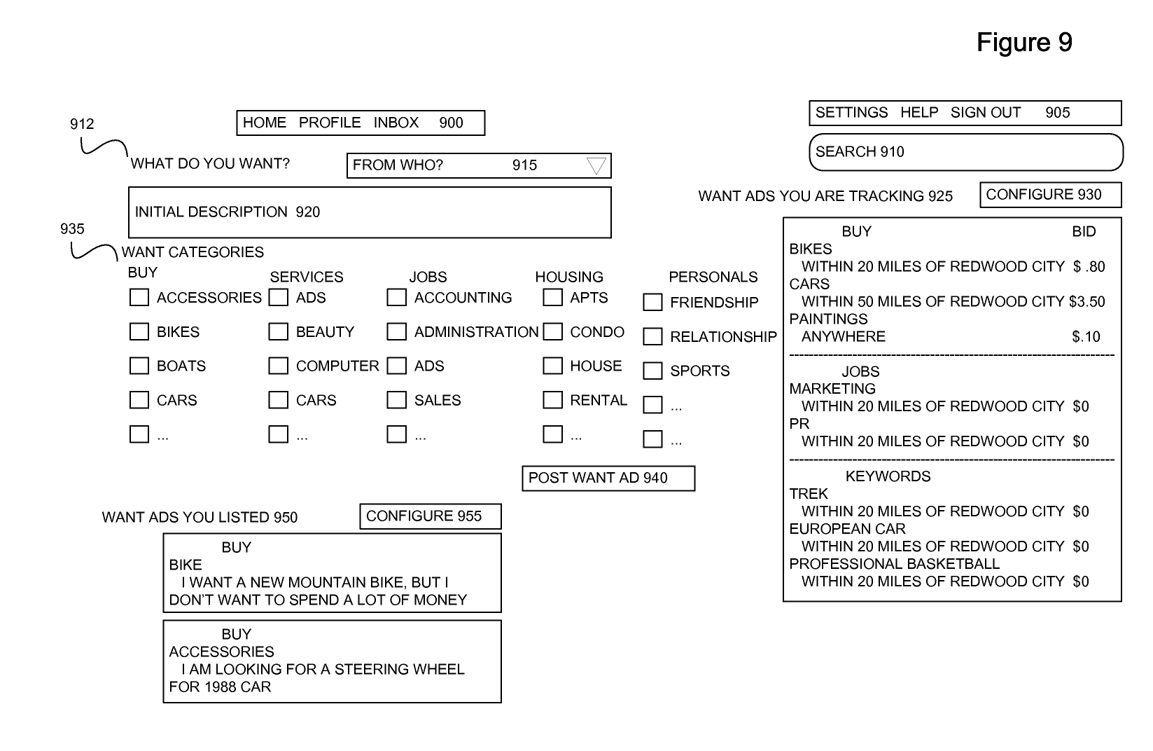

FIG. 9 illustrates an exemplary mechanism for a buyer to generate a want ad according to embodiments of the invention. For example, the online marketplace server 800 executes the buyer interaction module instructions 822 to provide the exemplary interface from FIG. 9 to a user acting as a buyer. FIG. 9 includes a primary navigation field 900, a secondary navigation field 905, a search field 910, a set of want ad generation fields 912, a want tracker listing 925, and a want ad listing 950. It should be understood that the number and type of fields illustrated in FIG. 9 are exemplary and alternative embodiments may have more fields, less fields, fields with combined functionality, etc.

The primary navigation field 900 is shown with three links: a link to the online marketplace home page, a link to the user's profile, and a link to the user's inbox. The secondary navigation field 905 is also shown with three links: a link to the user's settings, a link to a help information, and a link for the user to sign out of the online marketplace. The search field 910 allows the user to type in search terms that cause the online marketplace server to return a list of links corresponding to pages served by the online marketplace server that match, or are similar to, the terms provided within that field. For example, the user search for the keyword “car” returns a listing of public want ads with that keyword as well as would users' profiles with the word car as part of their username or in a description associated with their profile. After a search is entered and results are returned, the user may wish to use that search to generate a want ad or a want tracker based on the search terms used as a single user may act as both a buyer or seller in the system. Along with the search results, the online marketplace can provide a link to “Generate a want ad based on this search” and a link to “Generate a want tracker based on this search.”

The set of want ad generation fields 912 allows the buyer to input the requisite details needed for the online marketplace server to create and post a corresponding want ad. The set of fields comprises: a seller preference drop down selector 915, an initial description textbox 920, a want categorization input 935, and a post want ad button 940. In one embodiment, the seller preference drop down selector 915 allows the user to select a preference for commercial or non-commercial sellers. In another embodiment, the buyer may further select no preference from the seller preference drop down selector 915. The initial description textbox 920 allows the buyer to input a textual description of the desired want. In one embodiment, the buyer may categorize the want ad being generated into one of the predefined categories by checking one check box in the want categorization input 935; while in another embodiment, the buyer may select one or more predefined categories to categorize the want ad by checking all applicable check boxes in the want categorization input 935. In yet another embodiment, which is not illustrated, the buyer is provided a textbox in which the buyer enters keywords that are used by the online marketplace server to categorize the want ad. In response to the user clicking the post want ad button 940, the information entered within the set of want ad generation fields 912 is transmitted to the online marketplace server, which uses the information to generate and post the want ad to the online marketplace's website.

The want tracker listing 925 displays a lists of one or more want trackers that user created while acting as a seller in the online marketplace. It will be noted, that when generating the want ad in FIG. 9 the user is acting as a buyer within the marketplace but as such is not precluded from acting as a seller in other transactions. In one embodiment, the want tracker listing separates want trackers into the categories the want trackers are categorized. Further, the want tracker listing displays a short description of the want tracker, along with a bid value the seller has placed on the want tracker in embodiments utilizing a want tracker bid value system. However, in embodiments in which each bid is a fixed value, the bid column is omitted from the want tracker listing 925. The want tracker listing 925 further comprises a configure button 930 that allows the user to add, modify, and delete want trackers.

The want ad listing 950 provides a listing of one or more want ads that the user has previously posted. For example, a short description based on the details entered by the user may be displayed such that the user has a summary of each want ad. Further, the want ad listing 950 comprises a configure button 955 that allows the user to modify and delete existing want ads.

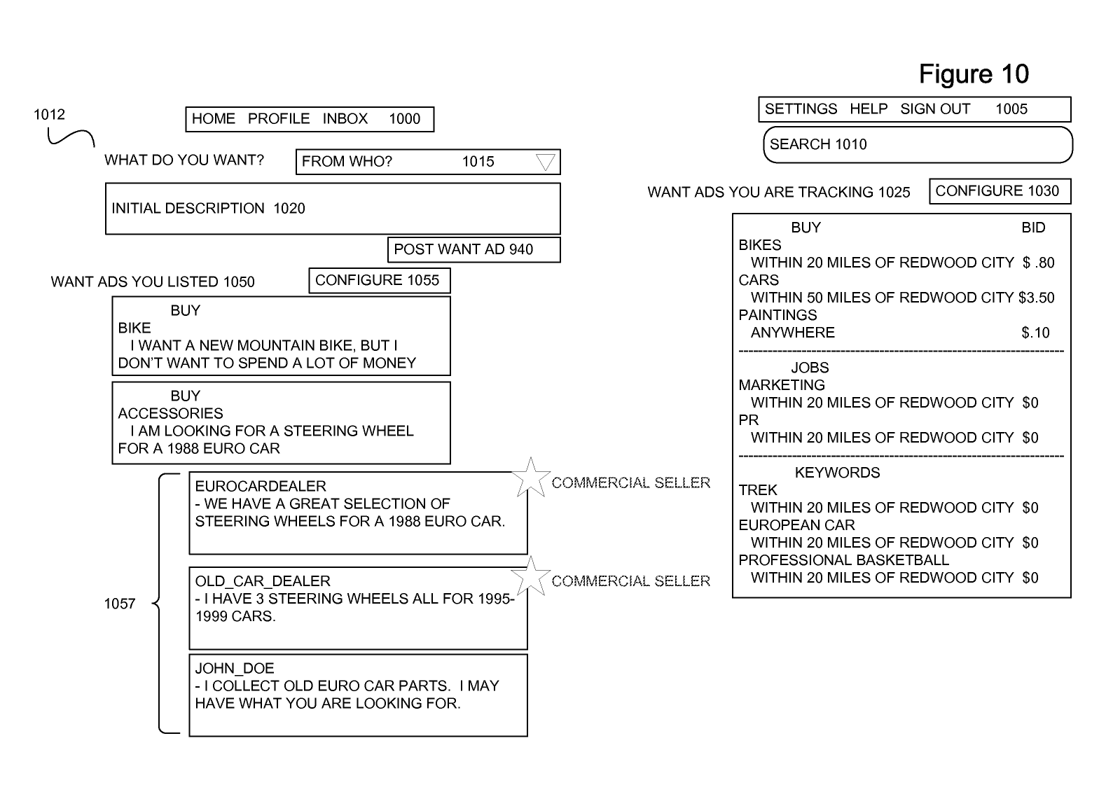

FIG. 10 illustrates an exemplary mechanism for a user to view want ads, responses, and want trackers according to embodiments of the invention. FIG. 10 is identical to FIG. 9 except that the set of want ad generation fields 1012 has been condensed to make room for a plurality of seller responses 1057 to one of that user's want ads. In this example, the user had listed a want ad categorized as a “BUY” for “ACCESSORIES.” The initial description of the want ad was “I am looking for a steering wheel for a 1998 Euro Car.” During the course of processing, the online marketplace has matched one or more want trackers with the want ad. For example, the online marketplace server 800 executes the want tracker module instructions 823 to match the want ads with one or more want trackers. Listed underneath the want ad are three responses 1057. The first two listed are from starred as coming from commercial sellers while the last response is not starred as it came from a non-commercial seller. Depending upon the privilege system used by the implementation of the online marketplace, the order of responses represents the order in which the sellers responded or represent a ranked display of the seller's responses. For example, if the buyer generated the corresponding want ad with a seller preference of commercial sellers, then the two commercial sellers may have sent their responses after the non-commercial seller but their responses rose to the top of the list based upon the buyer's preference; in another embodiment, the sellers' responses may be listed based upon the ranking of each response. For instance, the seller associated with the first response, shown as EUROCARDEALER, may have generated a want tracker with a higher bid than the second seller OLD_CAR_DEALER, or the first seller may have a higher reputation that the other two sellers.

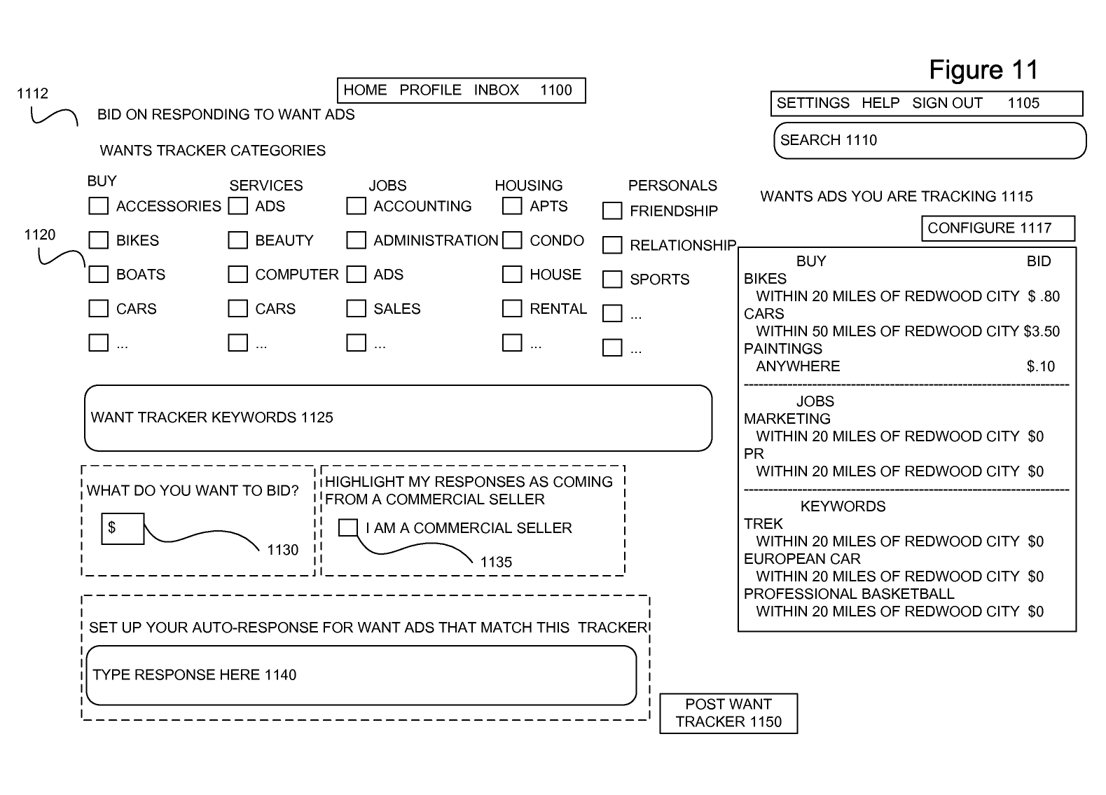

FIG. 11 illustrates an exemplary mechanism for a seller to generate want trackers according to embodiments of this invention. For example, the online marketplace server 800 executes the seller interaction module instructions 824 to provide the exemplary interface from FIG. 11 to a user acting as a seller. FIG. 11 includes a primary navigation field 1100, a secondary navigation field 1105, a search field 1110, a set of want tracker generation fields 1112, and a want tracker listing 1115.

The want tracker listing 1115 displays a lists of one or more want trackers that user previously created in the online marketplace. In one embodiment, the want tracker listing separates want trackers into the categories the want trackers are categorized. Further, the want tracker listing displays a short description of the want tracker, along with a bid value the seller has placed on the want tracker in embodiments utilizing a want tracker bid value system. However, in embodiments in which each bid is a fixed value, the bid column is omitted from the want tracker listing 1115. The want tracker listing 1115 further comprises a configure button 1117 that allows the user to add, modify, and delete want trackers.

The set of want tracker generation fields 1112 allows the seller to input the requisite details needed for the online marketplace server 800 to create a corresponding want tracker. The set of want tracker generation fields comprises: a want tracker categorization input 1120, a want tracker keywords textbox 1125, a post want tracker button 940. In one embodiment, the set of want tracker generation fields further comprises a bid value field 1130. In another embodiment, the set of want tracker generation fields further comprises a commercial or non-commercial seller indication 1135. Further, in embodiments supporting auto-responders as described above, the set of want tracker generation field further comprises a textbox in which the seller can enter a personalized response that will be automatically sent in response to want ads that match this want tracker. In one embodiment, the seller may categorize the want tracker being generated into one of the predefined categories by checking one check box in the want tracker categorization input 1120; while in another embodiment, the buyer may select one or more predefined categories to categorize the want ad by checking all applicable check boxes in the want tracker categorization input 1120. In yet another embodiment, which is not illustrated, the seller is provided a textbox in which the seller enters keywords that are used by the online marketplace server to categorize the want tracker. In response to the seller clicking the post want tracker button 1150, the information entered within the set of want tracker generation fields 1112 is transmitted to the online marketplace server 800, which uses the information to generate the want tracker. In response to generating the want tracker, the want tracker module instructions 823 are used by the online marketplace server 800 to match the want tracker with one or more want ads as described with reference to block 140 in FIG. 1.

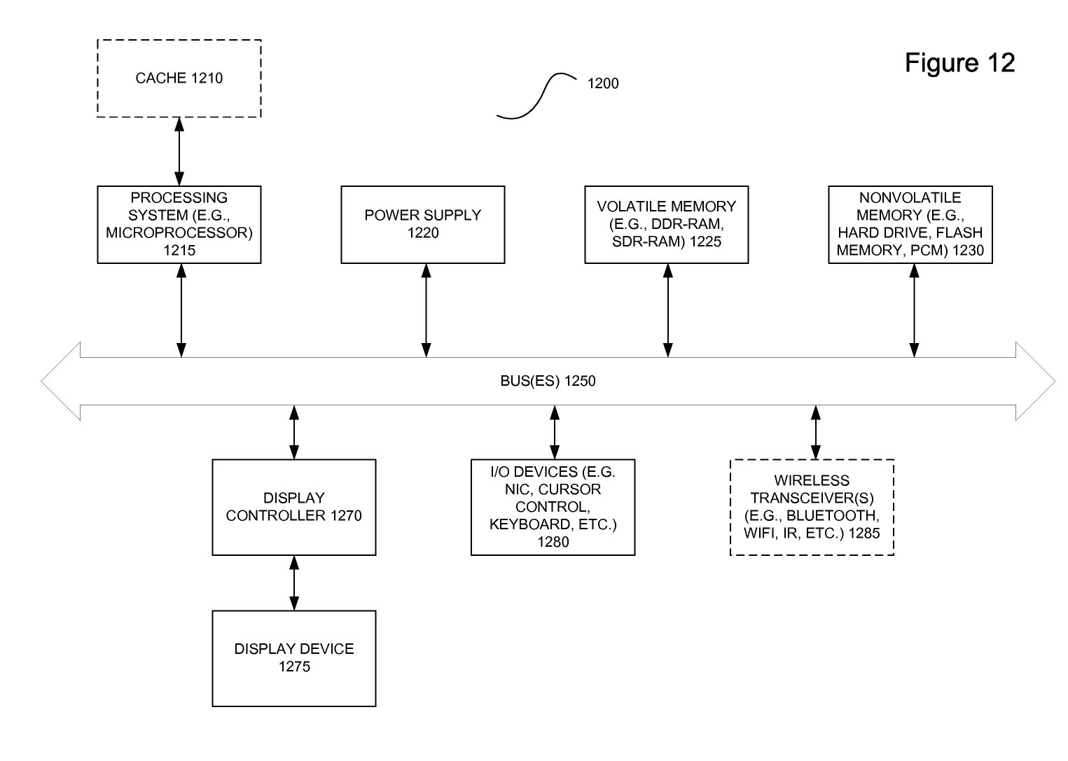

FIG. 12 is a block diagram illustrating an exemplary computer system according to embodiments of the invention. The exemplary computer system 1200 in FIG. 12 can be used to implement the online marketplace server 800 or used to implement the client computer 840. Those skilled in the art would recognize that other computer systems used to implement the online marketplace server 800 or client computer 840 may have more or less components and may be used to in embodiments of the invention.

The computer system 1200 includes a bus(es) 1250 which is coupled with a processing system 1215, a power supply 1220, volatile memory 1225 (e.g., double data rate random access memory (DDR-RAM), single data rate (SDR) RAM), nonvolatile memory 1230 (e.g., hard drive, flash memory, Phase-Change Memory (PCM). The processing system 1215 may be further coupled to a cache 1210. The processing system 1215 may retrieve instruction(s) from the volatile memory 1225 and/or the nonvolatile memory 1230, and execute the instruction to perform operations described above. The bus(es) 1250 couples the above components together and further couples a display controller 1270, one or more input/output devices 1280 (e.g., a network interface card, a cursor control (e.g., a mouse, trackball, touchscreen, touchpad, etc.), a keyboard, etc.), and, optionally, one or more wireless transceivers (e.g., Bluetooth, WiFi, Infrared, etc.). In one embodiment, the display controller 1270 is further coupled to a display device 1275.

While FIG. 12 illustrated a single exemplary computer system implementing embodiments of the invention herein, in alternative embodiments the online marketplace server is implemented by a plurality of computer systems (e.g., a cluster of computer systems).

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A computing device to provide want advertisements (want ads) to a plurality of want ad responders in an online marketplace, the computing device comprising:
a processor to execute instructions, and
a memory coupled with the processor, the memory storing instructions that when executed, cause the processor to generate the online marketplace, the online marketplace comprising:
a want ad responder interaction module to accept user input from the plurality of want ad responders to generate a plurality of want trackers, each want tracker to include details of one or more goods and services the want ad responder wishes to provide, wherein each want tracker is associated with an amount to be charged upon the granting of marketplace privileges;
a want ad submitter interaction module to accept user input from the plurality of want ad submitters to generate a plurality of want ads, each want ad to include details of desired goods or services and each want ad to be accessible by a group of potential want ad responders; and
a want tracker module, coupled to the want ad responder interaction module and the want ad submitter interaction module, to perform the following for each of the plurality of want ads:
match zero or more of the plurality of want trackers with the want ad based upon the details in the want ad and the details in the plurality of want trackers,
automatically rank the matching want trackers, and
automatically grant marketplace privileges to one or more want ad responders with matching want trackers based, at least, on their respective want trackers' rankings;
in response to granting the marketplace privileges, charging a fee to the want ad responders that were granted marketplace privileges, wherein each want ad responder's fee is at most the amount associated with that want ad responder's want tracker;
control a manner in which those of the plurality of want ad responders with matching want trackers may respond based on the sets of marketplace privileges their want trackers were granted, wherein the manner includes one or more of an ability to respond at all, a timing of responses, and an ordered transmission of responses; and
wherein the want ad submitter interaction module is also to transmit for each of the plurality of want ads the responses from those of the plurality of want ad responders with matching want trackers according to the manner.

2. The computing device of claim 1, wherein the group of potential want ad responders comprises all members of the online marketplace.

3. The computer device of claim 1, wherein the group of potential want ad responders is selected by the want ad submitter and comprises a plurality of members of the online marketplace.

4. The computing device of claim 1, wherein the want ad responder interaction module further accepts a bid amount corresponding to the value the want ad responder places on matching the want tracker to a want ad and wherein the automatic ranking of the matching want trackers is based upon, at least, the bid amount.

5. The computing device of claim 1, wherein the want ad responder interaction module is further to accept user input corresponding to whether each want tracker is generated by a commercial want ad responder or by a non-commercial want ad responder and wherein the want tracker module is to automatically grant each of the one or more matching want trackers privileges further based on whether each of the matching want trackers was generated by a commercial want ad responder or a non-commercial want ad responder.

6. The computing device of claim 1, wherein the set of one or more privileges granted to the one or more matching want trackers includes access to read the matching want ad at a specified time based upon the ranking of that matching want tracker such that the matching want trackers with higher rankings are granted access to read the matching want ad before the matching want trackers with lower rankings.

7. The computing device of claim 1, wherein the set of one or more privileges granted to the one or more matching want trackers includes a position in the transmission of responses to the matching want ad, the position in the transmission based upon the ranking of that matching want tracker such that responses from want ad responders with matching want trackers with higher ranking are granted a higher position in the transmission than responses from want ad responders with matching want trackers with lower rankings.

8. The computing device of claim 1, wherein the set of one or more privileges granted to the one or more matching want trackers includes access to send a response to the matching want ad at a specified time based upon the ranking of that matching want tracker such that matching want trackers with higher ranking are granted access to send responses to the watching want ad before the matching want trackers with lower rankings.

9. The method of claim 8, wherein the want tracker module is further to automatically generate the response to the matching want ad for the one or more matching want trackers.

10. The method of claim 9, wherein the want ad responder interaction module is further to accept user input corresponding to personalization input for each want tracker and the automatically generated response is based on the personalization input for the corresponding want tracker.

11. A non-transitory tangible machine-readable medium that provides instructions, if executed by a processor, will cause said processor to perform operations for an online marketplace, the operations comprising:
receiving user input from a plurality of want ad responders to generate a plurality of want trackers, each want tracker to include details of one or more goods and services the want ad responder wishes to provide, wherein each want tracker is associated with an amount to be charge upon the granting of marketplace privileges;
receiving user input from a plurality of want ad submitters to generate a plurality of want advertisements (want ads), each want ad to include details of desired goods or services and each want ad to be accessible by a group of potential want ad responders;
for each of the plurality of want ads:
matching zero or more of the plurality of want trackers with the want ad based upon details in the plurality of want trackers and details in the wants ad,
automatically ranking the one or more matching want trackers,
automatically granting marketplace privileges to one or more want ad responders with matching want trackers based, at least, on their respective want tracker's rankings,
in response to granting the marketplace privileges, charging a fee to the sellers that were granted marketplace privileges, wherein each seller's fee is at most the amount associated with that seller's want tracker, and
controlling a manner in which those of the plurality of want ad responders with matching want trackers may respond based on the set of marketplace privileges their want trackers were granted, wherein the manner includes one or more of an ability to respond at all, a timing of responses, and an ordered transmission of responses; and
transmitting one or more responses from different ones of the plurality of want ad responders with matching want trackers according to the manner.

12. The non-transitory tangible machine-readable medium of claim 11, wherein the group of potential want ad responders comprises all members of the online marketplace.

13. The non-transitory tangible machine-readable medium of claim 11, wherein the group of potential want ad responders is selected by the want ad submitter and comprises a plurality of members of the online marketplace.

14. The non-transitory tangible machine-readable medium of claim 11, wherein each want tracker further includes a bid amount corresponding to a value the want ad responder places on matching the want tracker to a want ad and the automatic ranking is based, at least, on the bid amount included within the details of the want trackers.

15. The non-transitory tangible machine-readable medium of claim 11, wherein the details of each want tracker further includes an indication of whether the want tracker was generated by a commercial want ad responder or by a non-commercial want ad responder and wherein the granting the one or more matching want trackers privileges is further based upon whether each of the match want trackers was generated by a commercial want ad responder or by a non-commercial want ad responder.

16. The non-transitory tangible machine-readable medium of claim 11, wherein the set of one or more privileges granted to the one or more matching want trackers includes access to read the matching want ad at a specified time based upon the ranking of that matching want tracker such that the matching want trackers with higher rankings are granted access to read the matching want tracker before the matching want trackers with lower rankings.

17. The non-transitory tangible machine-readable medium of claim 11, wherein the set of one or more privileges granted to the one or more matching want trackers includes a position in the transmission of responses to the matching want ad, the position in the transmission based upon the ranking of that matching want tracker such that response from want ad responders with matching want trackers with higher ranking are granted a higher position in the transmission than responses from want ad responders with matching want trackers with lower rankings.

18. The non-transitory tangible machine-readable medium of claim 11, wherein the set of one or more privileges granted to the one or more matching want trackers includes access to send a response to the matching want ad at a specified time based upon the ranking of that matching want tracker such that the matching want trackers with higher rankings are granted access to send responses to the matching want ad before the matching want trackers with lower rankings.

19. The non-transitory tangible machine-readable medium of claim 16, further comprising generating the response to the matching want ad for the one or more matching want trackers.

20. The non-transitory tangible machine-readable medium of claim 17, wherein the details of the one or more matching want trackers further includes personalization details and the generated response for each of the one or more matching want trackers is based upon the personalization details of that want tracker.

21. A method performed on an online market place computer comprising:
receiving user input from a plurality of want ad responders to generate a plurality of want trackers, each want tracker to include details of one or more goods and services the want ad responder wishes to provide, wherein each want tracker is associated with an amount to be charge upon the granting of marketplace privileges;
receiving user input from a plurality of want ad submitters to generate a plurality of want advertisements (want ads), each want ad to include details of desired goods or services and each want ad to be accessible by a group of potential want ad responders;
for each of the plurality of want ads:
matching zero or more of the plurality of want trackers with the want ad based upon details in the plurality of want trackers and details in the wants ad,
automatically ranking the one or more matching want trackers,
automatically granting marketplace privileges to one or more want ad responders with matching want trackers based, at least, on their respective want tracker's rankings,
in response to granting the marketplace privileges, charging a fee to the sellers that were granted marketplace privileges, wherein each seller's fee is at most the amount associated with that seller's want tracker, and
controlling a manner in which those of the plurality of want ad responders with matching want trackers may respond based on the set of marketplace privileges their want trackers were granted, wherein the manner includes one or more of an ability to respond at all, a timing of responses, and an ordered transmission of responses; and
transmitting one or more responses from different ones of the plurality of want ad responders with matching want trackers according to the manner.

22. The method of claim 21, wherein the group of potential want ad responders comprises all members of the online marketplace.

23. The method of claim 21, wherein the group of potential want ad responders is selected by the want ad submitter and comprises a plurality of members of the online marketplace.

24. The method of claim 21, wherein each want tracker further includes a bid amount corresponding to a value the want ad responder places on matching the want tracker to a want ad and the automatic ranking is based, at least, on the bid amount included within the details of the want trackers.

25. The method of claim 21, wherein the details of each want tracker further includes an indication of whether the want tracker was generated by a commercial want ad responder or by a non-commercial want ad responder and wherein the granting the one or more matching want trackers privileges is further based upon whether each of the match want trackers was generated by a commercial want ad responder or by a non-commercial want ad responder.

26. The method of claim 21, wherein the set of one or more privileges granted to the one or more matching want trackers includes access to read the matching want ad at a specified time based upon the ranking of that matching want tracker such that the matching want trackers with higher rankings are granted access to read the matching want tracker before the matching want trackers with lower rankings.

27. The method of claim 21, wherein the set of one or more privileges granted to the one or more matching want trackers includes a position in the transmission of responses to the matching want ad, the position in transmission based upon the ranking of that matching want tracker such that response from want ad responders with matching want trackers with higher ranking are granted a higher position in the transmission than responses from want ad responders with matching want trackers with lower rankings.

28. The method of claim 21, wherein the set of one or more privileges granted to the one or more matching want trackers includes access to send a response to the matching want ad at a specified time based upon the ranking of that matching want tracker such that the matching want trackers with higher rankings are granted access to send responses to the matching want ad before the matching want trackers with lower rankings.

29. The method of claim 28, further comprising generating the response to the matching want ad for the one or more matching want trackers.

30. The method of claim 29, wherein the details of the one or more matching want trackers further includes personalization details and the generated response for each of the one or more matching want trackers is based upon the personalization details of that want tracker.
